(19) United States
(12) Patent Application Publication
(10) Pub. No.: US 2005/0281234 A1
(43) Pub. Date: Dec. 22, 2005

(54) Communication terminal device

(75) Inventors: Yuzuru Kawamura, Tokyo (JP); Satoshi Oura, Tokyo (JP); Takuya Nishimura, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/147,776

(22) Filed: Jun. 8, 2005

(30) Foreign Application Priority Data
Jun. 18, 2004 (JP) 2004-181594

(51) Int. Cl. H04Q 7/24

(52) U.S. Cl. 370/338

(57) ABSTRACT

A communication terminal device includes a wireless LAN module configured to search a plurality of communication channels by channel scanning in order to find a communication channel available for communication and configured to perform wireless communication using the found communication channel through a wireless LAN. In a search process by channel scanning for searching for the communication channel available for communication, if the communication channel available for communication is not found within a predetermined time period from the beginning of the search process, the wireless LAN module stops the search process, and an operation mode of the wireless LAN module is shifted from a normal operation mode to a power-saving mode.

### BACKGROUND OF THE INVENTION

1. Field of the Invention

The present invention relates to a communication terminal device including a wireless local-area network (LAN) module. In particular, the present invention relates to a communication terminal device in which an operation mode of a wireless LAN module is shifted to a power-saving mode if a communication channel available for communication is not found within a predetermined time period from the beginning of searching for the communication channel available for communication.

2. Description of the Related Art

Generally, personal computers (PCs) with wireless LAN modules incorporated therein are known as communication terminal devices including wireless LAN modules. In particular, a portable laptop PC including a wireless LAN module is popular as an apparatus convenient to carry. In such a communication terminal device, the wireless LAN module searches by channel scanning for a communication channel available for communication with a target to be connected under the control of a controller of the portable laptop PC. If the communication channel available for communication with the target to be connected is found, the communication using the found communication channel becomes established. On the other hand, if the communication channel available for communication with the target to be connected is not found, the process for searching for the communication channel available for communication with the target to be connected is repeatedly performed, and the search processing continues until the communication channel available for communication with the target to be connected is found.

Since the portable laptop PC uses an internal battery as a driving power supply in most cases, performing such a search process for a long time causes the internal battery to be continuously exhausted during that process. As a result, if the communication channel available for communication with a target to be connected is found after the search process is performed over a relatively long time, the internal battery is significantly consumed, thus affecting a time period for which the communication with the target to be connected can last. Therefore, the communication with the target to be connected is not sufficiently performed without recharging the internal battery or replacing it with a new one.

### SUMMARY OF THE INVENTION

Accordingly, it is an object of the present invention to provide a communication terminal device capable of considerably reducing power consumption of a wireless LAN module in the case when a communication channel available for communication with a target to be connected is not found within a predetermined time period from the beginning of a process for searching for the communication channel.

According to an aspect of the present invention, a communication terminal device includes a wireless LAN module configured to search a plurality of communication channels by channel scanning in order to find a communication channel available for communication and configured to perform wireless communication using the found communication channel through a wireless LAN. If the communication channel available for communication is not found within a predetermined time period from the beginning of a search process for searching for the communication channel available for communication by channel scanning, the wireless LAN module stops the search process, and an operation mode of the wireless LAN module is shifted from a normal operation mode to a power-saving mode.

The power-saving mode of the wireless LAN module may be the mode in which power is not supplied to a radio-frequency (RF) unit in the wireless LAN module.

The power-saving mode of the wireless LAN module may be the mode in which power is not supplied to each unit, including a radio-frequency (RF) unit, in the wireless LAN module.

As described above, in the communication terminal device according to one aspect of the present invention, in a search process for searching for the communication channel available for communication by channel scanning executed by the wireless LAN module, in the case when the communication channel available for communication is not found within a predetermined time period from the beginning of the search process, the search process is stopped and an operation mode of the wireless LAN module is shifted from the normal operation mode to the power-saving mode. Therefore, consumption of power used in searching for the communication channel is minimized. Even if a driving power source is an internal battery, the consumption of the internal battery is significantly reduced, thus increasing battery life.

### BRIEF DESCRIPTION OF THE DRAWINGS

FIG. 1 is a block diagram of a communication terminal device according to an embodiment of the present invention, showing main parts; and

FIG. 2 is a flowchart showing the operation of the communication terminal device shown in FIG. 1 when a process for searching for a communication channel available for communication is performed.

### DESCRIPTION OF THE PREFERRED EMBODIMENTS

The embodiment is described below with reference to the drawings.

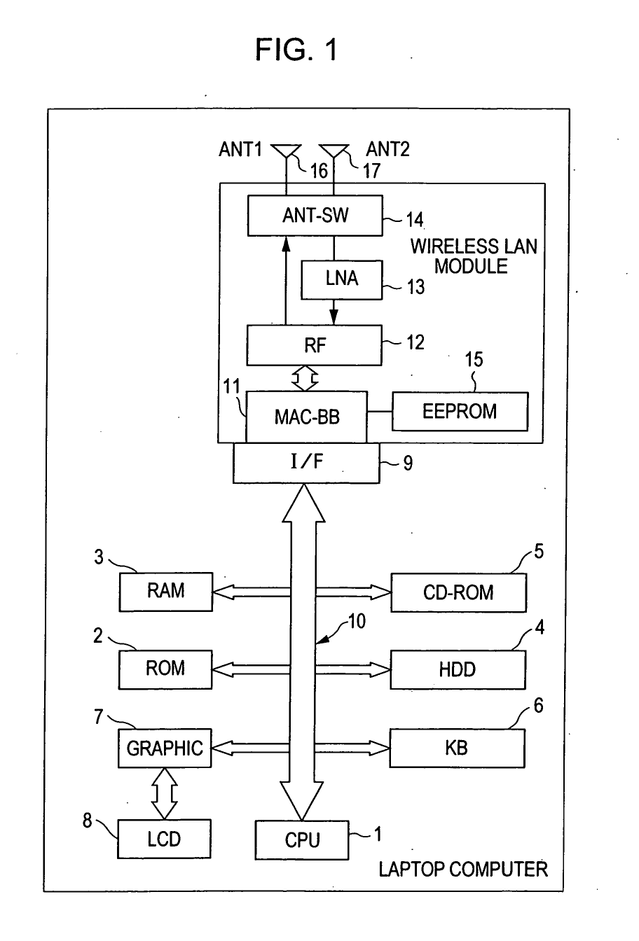

FIG. 1 is a block diagram of a communication terminal device according to the embodiment, showing main parts.

As shown in FIG. 1, the communication terminal device according to the embodiment is composed of a portable laptop PC main body (LAPTOP COMPUTER) and a wireless LAN module (WIRELESS LAN MODULE) incorporated in a card slot or the like of the portable laptop PC main body. In this embodiment, the portable laptop PC main body includes a controller (CPU) 1, a read-only memory (ROM) 2, a random-access memory (RAM) 3, a hard disk drive (HDD) 4, a compact disk ROM drive (CD-ROM) 5, a key operating unit (KB) 6, an image forming unit (GRAPHIC) 7, a liquid crystal display (LCD) 8, an internal interface (I/F) 9, and a bas line 10. The wireless LAN module includes a baseband processing unit (MAC-BB) 11, a radio-frequency transmitting and receiving unit (RF) 12, a low-noise amplifier (LNA) 13, an antenna switch (ANT-SW) 14, a memory unit (EEPROM) 15, a first antenna (ANT1) 16, and a second antenna (ANT2) 17. The portable laptop PC main body and the wireless LAN module are connected to each other by connecting the baseband processing unit 11 of the wireless LAN module to the internal interface 9 of the portable PC main body.

In the laptop PC main body, the controller 1, the ROM 2, the RAM 3, the hard disk drive 4, the CD-ROM drive 5, the key operating unit 6, the image forming unit 7, and the internal interface 9 are connected to each other with the bus line 10 therebetween. The liquid crystal display 8 is directly connected to the image forming unit 7. In the wireless LAN module, the baseband processing unit 11 is connected to the memory unit 15 and is also connected to a baseband signal input/output terminal of the radio-frequency transmitting and receiving unit 12. A radio-frequency signal output terminal of the radio-frequency transmitting and receiving unit 12 is connected to the first antenna 16, which is used for transmission. A radio-frequency signal input terminal of the radio-frequency transmitting and receiving unit 12 is connected to a signal output terminal of the low-noise amplifier 13. The low-noise amplifier 13 is connected to the second antenna 17, which is used for reception.

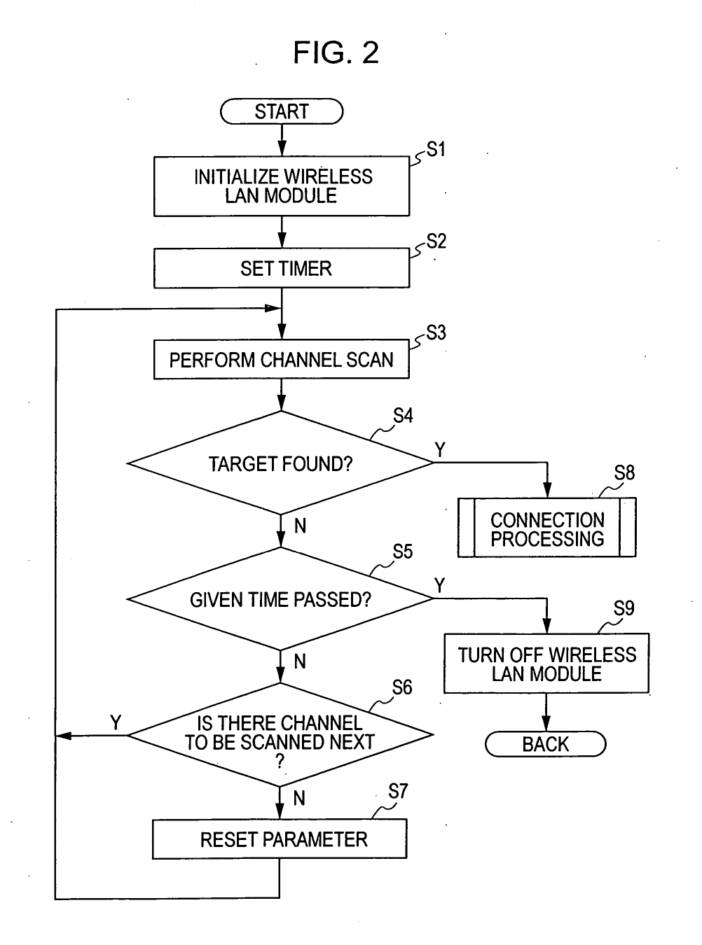

FIG. 2 is a flowchart showing the operation of the communication terminal device shown in FIG. 1 when a process for searching for a communication channel available for communication is performed.

The process for searching for the communication channel available for communication executed in the communication terminal device shown in FIG. 1 is described below with reference to FIG. 2.

In step S1, the controller 1 initializes the wireless LAN module settings so that the wireless LAN module is in a state suited for a search process for searching for the communication channel by channel scanning when starting control upon the activation of a driver and a utility for the wireless LAN module after power is supplied to the wireless LAN module or when receiving an instruction from a user to search for the communication channel available for communication with a target to be connected.

In step S2, the controller 1 sets an embedded timer (not shown) for a predetermined time period and starts a counter of the timer before the wireless LAN module performs the channel scanning.

In step S3, the controller 1 makes the wireless LAN module execute the channel scanning searching for the communication channel available for communication with a target to be connected.

In step S4, the controller 1 determines whether the target to be connected has been found in a search process by the channel scanning executed by the wireless LAN module. If the controller 1 determines that the target to be connected has not been found (“N” prong in step S4), the processing moves to step S5. On the other hand, if the controller 1 determines that the target to be connected has been found (“Y” prong), the processing moves to step S8.

In step S5, the controller 1 determines whether a counter reading of the timer has reached the set predetermined time period. If the controller 1 determines that the counter reading has not reached the set predetermined time period (“N” prong), the processing moves to step S6. On the other hand, if the controller 1 determines that the counter reading has reached the set predetermined time period (“Y” prong), the processing moves to step S9. The predetermined time period is not uniquely defined because it depends on a state of a wireless LAN to be targeted, the structure of the laptop PC main body, and the like. In general, however, the time period is set in a preferable range of from 10 seconds to 30 seconds, for example.

In step S6, the controller 1 determines whether there is a communication channel to be scanned next. If the controller 1 determines that there is no communication channel to be scanned next (“N” prong), the processing moves to step S7. On the other hand, if the controller 1 determines that there is a communication channel to be scanned next (“Y” prong), the processing returns to step S3, and the subsequent steps are performed.

In step S7, the controller 1 resets a parameter for use when the wireless LAN module performs channel scanning for searching for the communication channel available for communication with the target to be connected. After the parameter is reset, the processing returns to step S3, and the subsequent steps are performed.

In step S8, since the communication channel available for communication with the target to be connected has been found in the process in which the wireless LAN module performs the channel scanning, the controller 1 carries out connection processing with respect to the target using the found communication channel, so that the connection to the target is established with the found communication channel.

In step S9, since the communication channel available for communication with the target to be connected has not been found within the predetermined time period from the beginning of the channel scanning searching for the communication channel available for communication, the controller 1 stops supplying power to the radio-frequency transmitting and receiving unit 12, and shifts an operation mode of the wireless LAN module from a normal operation mode to a power-saving mode. As an alternative to stopping supplying power to the radio-frequency transmitting and receiving unit 12 of the wireless LAN module, supplying power to the entire system of the wireless LAN module may be stopped.

Accordingly, in the communication terminal device according to this embodiment of the present invention, if the communication channel available for communication with the target to be connected has been found before the predetermined time period elapses from the beginning of the channel scanning searching for the communication channel available for communication, the connection to the target is established with the found communication channel. On the other hand, if the communication channel available for communication with the target to be connected has not been found within the predetermined time period from the beginning of the channel scanning searching for the communication channel available for communication, the channel scanning searching for the communication channel available for communication is stopped, and the operation mode of the wireless LAN module is shifted from the normal operation mode to the power-saving mode. Therefore, the power consumption of the communication terminal device, in particular, that of the internal battery can be minimized, thus expanding the life of the internal battery. As a result, the communication terminal device can communicate with the target to be connected without poor communications due to power shortage.

In the communication terminal according to the embodiment described above, a portable laptop computer is used as an apparatus including a wireless LAN module. However, such an apparatus is not limited to this. The apparatus may be a stationary laptop PC, a desktop PC, or other apparatuses similar to the laptop PC.

The explanation about the operation of the communication terminal device shown in FIG. 1 is focused on the process for searching for the communication channel available for communication, the process being performed in the communication terminal device. Other operations are substantially the same as those of well-known communication terminal devices of this type. Therefore, the operations other than the process for searching for the communication channel available for communication are not explained here.

1. A communication terminal device comprising:
a wireless local-area network (LAN) module configured to search a plurality of communication channels by channel scanning in order to find a communication channel available for communication and configured to perform wireless communication using the found communication channel through a wireless LAN,
wherein, in a search process by channel scanning for searching for the communication channel available for communication, if the communication channel available for communication is not found within a predetermined time period from the beginning of the search process, the wireless LAN module stops the search process, and an operation mode of the wireless LAN module is shifted from a normal operation mode to a power-saving mode.

2. The communication terminal device according to claim 1, wherein the power-saving mode is a mode in which power is not supplied to a radio-frequency (RF) unit in the wireless LAN module.

3. The communication terminal device according to claim 1, wherein the power-saving mode is a mode in which power is not supplied to each unit, including a radio-frequency (RF) unit, in the wireless LAN module.
